(19) United States
(12) Patent Application Publication
(10) Pub. No.: US 2008/0153970 A1
(43) Pub. Date: Jun. 26, 2008

(54) Solvent sprayable contact adhesive formulations from functionalized/controlled distribution block copolymers

(75) Inventor: Lydia Ann Salazar, Katy, TX (US)

Correspondence Address: KRATON POLYMERS U.S. LLC, WESTHOLLOW TECHNOLOGY CENTER, 3333 HIGHWAY 6 SOUTH, HOUSTON, TX, 77082, US

(73) Assignee: Kraton Polymers U.S. LLC, Houston, TX (US)

(21) Appl. No.: 11/643,106

(22) Filed: Dec. 21, 2006

(51) Int. Cl. C08L 53/00

(52) U.S. Cl. 524/505

(57) ABSTRACT

The invention relates to a solvent sprayable contact adhesive composition comprising (i) one or more styrenic block copolymer compositions, (ii) a tackifying resin, (iii) a solvent and (iv) optionally one or more plasticizers, wherein said styrenic block copolymer composition comprises a selectively hydrogenated and functionalized controlled distribution block copolymer having monoalkenyl arene end blocks and hydrogenated controlled distribution mid blocks containing certain mixtures of monoalkenyl arene and conjugated diene.

### BACKGROUND OF THE INVENTION

1. Field of the Invention

This invention relates to a solvent sprayable contact adhesive composition containing a functionalized, selectively hydrogenated block copolymer having a controlled distribution of styrene and diene in the mid block prior to hydrogenation.

2. Background of the Art

Adhesive compositions based on styrenic block copolymers as thermoplastic elastomeric components are well known in the art. Styrenic block copolymers (“SBC's”) have a long history of use in adhesives, sealants and coatings. For example, U.S. Pat. No. 3,239,478 (“Harlan”) discloses adhesives comprising unsaturated styrene-isoprene-styrene block copolymers (“SIS”) and styrene-butadiene-styrene block copolymers (“SBS”) in adhesives and sealants. Harlan also broadly discloses adhesives comprising the hydrogenated S-B-S (i.e. “SEBS”) and hydrogenated S-I-S (i.e. “SEPS”) block copolymers with tackifying resins and extender oils for a variety of adhesives and sealants, including pressure sensitive adhesives.

These compositions are for instance used as PSA (pressure sensitive adhesive) for industrial tapes, packaging tapes and labels, and in multipurpose hot-melt adhesive compositions which may be used to bond or construct articles in the manufacture of disposable soft goods, such as diapers, feminine care articles, surgical drapes and the like.

US Published Patent Application 2005/0119403 discloses low viscosity, high solids content coatings based on hydrogenated S-EB-S block copolymers which have a low level of volatile organics compounds (VOC) meeting California VOC regulations and which can be spray applied as a coating on a variety of surfaces.

U.S. Pat. No. 6,987,142 disclose adhesives based on selectively hydrogenated, controlled distribution S-EB/S-S block copolymers, tackifying resins, oils and other components. However, it does not disclose adhesives that would meet California VOC regulations, nor does it disclose spray application as a coating.

What is needed is a solvent sprayable adhesive that achieves low VOC while providing improved properties.

### SUMMARY OF THE INVENTION

The present invention broadly encompasses a solvent sprayable contact adhesive formulation that has superior properties when compared against prior art formulations. The key to the improvement in properties is use of a selectively hydrogenated and functionalized block copolymer having monoalkenyl arene end blocks, and hydrogenated midblocks containing a controlled distribution of monoalkenyl arene and conjugated diene (hereinafter referred to as “FUNCTIONALIZED S-EB/S-S” block copolymers). As shown in the examples that follow, FUNCTIONALIZED S-EB/S-S contact adhesive formulations have improved performance in adhesion to polyurethane foam when compared to SEBS block copolymers. In particular, the present invention is a solvent sprayable contact adhesive composition comprising (i) one or more block copolymers, (ii) one or more tackifying resins, (iii) one or more solvents and (iii) optionally, one or more plasticizers, wherein at least one of the block copolymers is a block copolymer composition comprising:

a functionalized, selectively hydrogenated block copolymer having the general configuration A-B, A-B-A, (A-B)ₙ, (A-B-A)ₙ, (A-B-A)ₙX, (A-B)ₙX or mixtures thereof, where n is an integer from 2 to about 30, and X is coupling agent residue and which has been grafted with an acid compound or its derivative wherein:
a. prior to hydrogenation each A block is a mono alkenyl arene polymer block and each B block is a controlled distribution copolymer block of at least one conjugated diene and at least one mono alkenyl arene;
b. subsequent to hydrogenation about 0-10% of the arene double bonds have been reduced, and at least about 90% of the conjugated diene double bonds have been reduced;
c. each A block having a number average molecular weight between about 3,000 and about 60,000 and each B block having a number average molecular weight between about 30,000 and about 300,000;
d. each B block comprises terminal regions adjacent to the A blocks that are rich in conjugated diene units and one or more regions not adjacent to the A blocks that are rich in mono alkenyl arene units;
e. the total amount of mono alkenyl arene in the hydrogenated block copolymer is about 20 percent weight to about 80 percent weight; and
f. the weight percent of mono alkenyl arene in each B block is between about 10 percent and about 75 percent.

One advantage for solvent sprayable adhesives is that the rate of evaporation for solvent based adhesives can be greater than water based adhesives, thus achieving shorter assembly time. Also, solvent sprayable adhesives can be supplied in canisters thus providing a convenient portable size. As shown in the examples which follow, the use of FUNCTIONALIZED S-EB/S-S block copolymers resulted in higher 180° Peel (canvas to PU foam) compared to the prior art formulations based on S-EB-S block copolymers or maleated S-EB-S block copolymers. Failure mode for adhesives formulated with FUNCTIONALIZED S-EB/S-S was foam tear where other polymers failed mostly cohesively. A foam tear failure is an indication the adhesive bond was stronger than the foam. Both formulated polar polymers (maleated S-EB-S and FUNCTIONALIZED S-EB/S-S) gave higher solids at a given viscosity with t-butyl acetate (tBAC)/heptane blends. TBAc is a non-HAP, VOC exempt solvent in most US states. Also, the FUNCTIONALIZED S-EB/S-S block copolymer is more polar compared to SEBS block copolymers, and this will improve adhesion to polar substrates.

### DETAILED DESCRIPTION OF THE PREFERRED EMBODIMENTS

### A. Block Copolymers with Controlled Distribution Midblocks

The key component of the present invention is the novel block copolymer containing mono alkenyl arene end blocks and a unique mid block of a mono alkenyl arene and a conjugated diene. Such polymers are disclosed in U.S. Pat. No. 7,067,589. Surprisingly, the combination of (1) a unique control for the monomer addition and (2) the use of diethyl ether or other modifiers as a component of the solvent (which will be referred to as “distribution agents”) results in a certain characteristic distribution of the two monomers (herein termed a “controlled distribution” polymerization, i.e., a polymerization resulting in a “controlled distribution” structure), and also results in the presence of certain mono alkenyl arene rich regions and certain conjugated diene rich regions in the polymer block. For purposes hereof, “controlled distribution” is defined as referring to a molecular structure having the following attributes: (1) terminal regions adjacent to the mono alkenyl arene homopolymer (“A”) blocks that are rich in (i.e., have a greater than average amount of) conjugated diene units; (2) one or more regions not adjacent to the A blocks that are rich in (i.e., have a greater than average amount of) mono alkenyl arene units; and (3) an overall structure having relatively low blockiness. For the purposes hereof, “rich in” is defined as greater than the average amount, preferably greater than 5% the average amount. This relatively low blockiness can be shown by either the presence of only a single (“Tg,”) intermediate between the Tg's of either monomer alone, when analyzed using differential scanning calorimetry (“DSC”) (thermal) methods or via mechanical methods, or as shown via proton nuclear magnetic resonance (“H-NMR”) methods. The potential for blockiness can also be inferred from measurement of the UV-visible absorbance in a wavelength range suitable for the detection of polystyryllithium end groups during the polymerization of the B block. A sharp and substantial increase in this value is indicative of a substantial increase in polystyryllithium chain ends. In this process, this will only occur if the conjugated diene concentration drops below the critical level to maintain controlled distribution polymerization. Any styrene monomer that is present at this point will add in a blocky fashion. The term “styrene blockiness”, as measured by those skilled in the art using proton NMR, is defined to be the proportion of S units in the polymer having two S nearest neighbors on the polymer chain. The styrene blockiness is determined after using H-1 NMR to measure two experimental quantities as follows:

First, the total number of styrene units (i.e. arbitrary instrument units which cancel out when ratioed) is determined by integrating the total styrene aromatic signal in the H-1 NMR spectrum from 7.5 to 6.2 ppm and dividing this quantity by 5 to account for the 5 aromatic hydrogens on each styrene aromatic ring.

Second, the blocky styrene units are determined by integrating that portion of the aromatic signal in the H-1 NMR spectrum from the signal minimum between 6.88 and 6.80 to 6.2 ppm and dividing this quantity by 2 to account for the 2 ortho hydrogens on each blocky styrene aromatic ring. The assignment of this signal to the two ortho hydrogens on the rings of those styrene units which have two styrene nearest neighbors was reported in F. A. Bovey, High Resolution NMR of Macromolecules (Academic Press, New York and London, 1972), chapter 6.

The styrene blockiness is simply the percentage of blocky styrene to total styrene units:

Blocky %=100 times(Blocky Styrene Units/Total Styrene Units)

Expressed thus, Polymer-Bd-S-(S)n-S-Bd-Polymer, where n is greater than zero is defined to be blocky styrene. For example, if n equals 8 in the example above, then the blockiness index would be 80%. It is preferred that the blockiness index be less than about 40. For some polymers, having styrene contents of ten weight percent to forty weight percent, it is preferred that the blockiness index be less than about 10.

This controlled distribution structure is very important in managing the strength and Tg of the resulting copolymer, because the controlled distribution structure ensures that there is virtually no phase separation of the two monomers, i.e., in contrast with block copolymers in which the monomers actually remain as separate “microphases”, with distinct Tg's, but are actually chemically bonded together. This controlled distribution structure assures that only one Tg is present and that, therefore, the thermal performance of the resulting copolymer is predictable and, in fact, predeterminable. Furthermore, when a copolymer having such a controlled distribution structure is then used as one block in a di-block, tri-block or multi-block copolymer, the relatively higher Tg made possible by means of the presence of an appropriately constituted controlled distribution copolymer region will tend to improve flow and processability. Modification of certain other properties is also achievable.

In a preferred embodiment of the present invention, the subject controlled distribution copolymer block has three distinct regions—conjugated diene rich regions on the end of the block and a mono alkenyl arene rich region near the middle or center of the block. Typically the region adjacent to the A block comprises the first 15 to 25% of the block and comprises the diene rich region(s), with the remainder considered to be arene rich. The term “diene rich” means that the region has a measurably higher ratio of diene to arene than the arene rich region. What is desired is a mono alkenyl arene/conjugated diene controlled distribution copolymer block, wherein the proportion of mono alkenyl arene units increases gradually to a maximum near the middle or center of the block (when describing an ABA structure) and then decreases gradually until the polymer block is fully polymerized. This structure is distinct and different from the tapered and/or random structures discussed in the prior art.

Starting materials for preparing the novel controlled distribution copolymers of the present invention include the initial monomers. The alkenyl arene can be selected from styrene, alpha-methylstyrene, para-methylstyrene, vinyl toluene, vinylnaphthalene, and para-butyl styrene or mixtures thereof. Of these, styrene is most preferred and is commercially available, and relatively inexpensive, from a variety of manufacturers. The conjugated dienes for use herein are 1,3-butadiene and substituted butadienes such as isoprene, piperylene, 2,3-dimethyl-1,3-butadiene, and 1-phenyl-1,3-butadiene, or mixtures thereof. Of these, 1,3-butadiene is most preferred. As used herein, and in the claims, “butadiene” refers specifically to “1,3-butadiene”.

As used herein, “thermoplastic block copolymer” is defined as a block copolymer having at least a first block of a mono alkenyl arene, such as styrene and a second block of a controlled distribution copolymer of diene and mono alkenyl arene. The method to prepare this thermoplastic block copolymer is via any of the methods generally known for block polymerizations. The present invention includes as an embodiment a thermoplastic copolymer composition, which may be either a di-block, tri-block copolymer or multi-block composition. In the case of the di-block copolymer composition, one block is the alkenyl arene-based homopolymer block and polymerized therewith is a second block of a controlled distribution copolymer of diene and alkenyl arene. In the case of the tri-block composition, it comprises, as end-blocks the glassy alkenyl arene-based homopolymer and as a mid-block the controlled distribution copolymer of diene and alkenyl arene. Where a tri-block copolymer composition is prepared, the controlled distribution diene/alkenyl arene copolymer can be herein designated as “B” and the alkenyl arene-based homopolymer designated as “A”.

The A-B-A, tri-block compositions can be made by either sequential polymerization or coupling. In the sequential solution polymerization technique, the mono alkenyl arene is first introduced to produce the relatively hard aromatic block, followed by introduction of the controlled distribution diene/alkenyl arene mixture to form the mid block, and then followed by introduction of the mono alkenyl arene to form the terminal block. In addition to the linear, A-B-A configuration, the blocks can be structured to form a radial (branched) polymer, (A-B)ₙX or (A-B-A)ₙX, or both types of structures can be combined in a mixture. Some A-B diblock polymer can be present but preferably at least about 70 weight percent of the block copolymer is A-B-A or radial (or otherwise branched so as to have 2 or more terminal resinous blocks per molecule) so as to impart strength. Other structures include (A-B)ₙ and (A-B)ₙA. In the above formulas, n is an integer from 2 to about 30, preferably 2 to about 15, more preferably 2 to 6 and X is the remnant or residue of the coupling agent.

It is also important to control the molecular weight of the various blocks. For an AB diblock, desired block molecular weights are 3,000 to about 60,000 for the mono alkenyl arene A block, and 30,000 to about 300,000 for the controlled distribution conjugated diene/mono alkenyl arene B block. Preferred ranges are 5,000 to 45,000 for the A block and 50,000 to about 250,000 for the B block. For the triblock, which may be a sequential ABA or coupled (AB)₂ X block copolymer, the A blocks should be 3,000 to about 60,000, preferably 5,000 to about 45,000, while the B block for the sequential block should be about 30,000 to about 300,000, and the B blocks (two) for the coupled polymer half that amount. The total average molecular weight for the triblock copolymer should be from about 40,000 to about 400,000, and for the radial copolymer from about 60,000 to about 600,000. These molecular weights are most accurately determined by light scattering measurements, and are expressed as number average molecular weights.

Another important aspect of the present invention is to control the microstructure or vinyl content of the conjugated diene in the controlled distribution copolymer block. The term “vinyl content” refers to the fact that a conjugated diene is polymerized via 1,2-addition (in the case of butadiene—it would be 3,4-addition in the case of isoprene). Although a pure “vinyl” group is formed only in the case of 1,2-addition polymerization of 1,3-butadiene, the effects of 3,4-addition polymerization of isoprene (and similar addition for other conjugated dienes) on the final properties of the block copolymer will be similar. The term “vinyl” refers to the presence of a pendant vinyl group on the polymer chain. When referring to the use of butadiene as the conjugated diene, it is preferred that about 20 to about 80 mol percent of the condensed butadiene units in the copolymer block have 1,2 vinyl configuration as determined by proton NMR analysis, preferably about 30 to about 80 mol percent of the condensed butadiene units should have 1,2-vinyl configuration. This is effectively controlled by varying the relative amount of the distribution agent. As will be appreciated, the distribution agent serves two purposes—it creates the controlled distribution of the mono alkenyl arene and conjugated diene, and also controls the microstructure of the conjugated diene. Suitable ratios of distribution agent to lithium are disclosed and taught in US Pat. Re 27,145, which disclosure is incorporated by reference.

For the controlled distribution or B block the weight percent of mono alkenyl arene in each B block is between about 10 weight percent and about 75 weight percent, preferably between about 25 weight percent and about 50 weight percent.

An important feature of the thermoplastic elastomeric di-block and tri-block polymers of the present invention, including one or more controlled distribution diene/alkenyl arene copolymer blocks and one or more mono alkenyl arene blocks, is that they have at least two Tg's, the lower being the single Tg of the controlled distribution copolymer block which is an intermediate of its constituent monomers' Tg's. Such Tg is preferably at least above about −60 degrees C., more preferably from about −40 degrees C. to about +30 degrees C., and most preferably from about −40 degrees C. to about +10 degrees C. The second Tg, that of the mono alkenyl arene “glassy” block, is preferably more than about +80 degrees C., more preferably from about +80 degrees C. to about +110 degrees C. The presence of the two Tg's, illustrative of the microphase separation of the blocks, contributes to the notable elasticity and strength of the material in a wide variety of applications, and its ease of processing and desirable melt-flow characteristics.

The block copolymer is selectively hydrogenated. Hydrogenation can be carried out via any of the several hydrogenation or selective hydrogenation processes known in the prior art. For example, such hydrogenation has been accomplished using methods such as those taught in, for example, U.S. Pat. Nos. 3,494,942; 3,634,594; 3,670,054; 3,700,633; and Re. 27,145. Hydrogenation can be carried out under such conditions that at least about 90 percent of the conjugated diene double bonds have been reduced, and between zero and 10 percent of the arene double bonds have been reduced. Preferred ranges are at least about 95 percent of the conjugated diene double bonds reduced, and more preferably about 98 percent of the conjugated diene double bonds are reduced. Alternatively, it is possible to hydrogenate the polymer such that aromatic unsaturation is also reduced beyond the 10 percent level mentioned above. In that case, the double bonds of both the conjugated diene and arene may be reduced by 90 percent or more.

The block copolymer of the present invention is functionalized with an unsaturated monomer having one or more functional groups or their derivatives, such as carboxylic acid groups and their salts, anhydrides, esters, imide groups, amide groups, and acid chlorides. The preferred monomers to be grafted onto the block copolymers are maleic anhydride, maleic acid, fumaric acid, and their derivatives. A further description of functionalizing such block copolymers can be found in Gergen et al, U.S. Pat. No. 4,578,429 and in U.S. Pat. No. 5,506,299, which disclosures are incorporated by reference.

In general, any materials having the ability to react with the base polymer, in free radical initiated reactions are operable for the purposes of the invention.

In order to incorporate functional groups into the base polymer, monomers capable of reacting with the base polymer, for example, in solution or in the melt by free radical mechanism are necessary. Monomers may be polymerizable or nonpolymerizable, however, preferred monomers are nonpolymerizable or slowly polymerizing. The monomers must be ethylenically unsaturated in order to take part in free radical reactions. By grafting unsaturated monomers which have a slow polymerization rate, the resulting graft copolymers contain little or no homopolymer of the unsaturated monomer and contain only short grafted monomer chains which do not separate into separate domains.

The class of preferred monomers which will form graft polymers within the scope of the present invention have one or more functional groups or their derivatives such as carboxylic acid groups and their salts, anhydrides, esters, imide groups, amide groups, acid chlorides and the like in addition to at least one point of unsaturation. These functionalities can be subsequently reacted with other modifying materials to produce new functional groups. For example a graft of an acid-containing monomer could be suitably modified by esterifying the resulting acid groups in the graft with appropriate reaction with hydroxy-containing compounds of varying carbon atoms lengths. The reaction could take place simultaneously with the grafting or in a subsequent post modification reaction.

The grafted polymer will usually contain from 0.02 to 20, preferably 0.1 to 10, and most preferably 0.2 to 5 weight percent of grafted portion.

The preferred modifying monomers are unsaturated mono- and polycarboxylic-containing acids (C₃-C₁₀) with preferably at least one olefinic unsaturation, and anhydrides, salts, esters, ethers, amides, nitriles, thiols, thioacids, glycidyl, cyano, hydroxy, glycol, and other substituted derivatives from said acids. Examples of such acids, anhydrides and derivatives thereof include maleic acid, fumaric acid, itaconic acid, citraconic acid, acrylic acid, glycidyl acrylate, cyanoacrylates, hydroxy C₁-C₂₀ alkyl methacrylates, acrylic polyethers, acrylic anhydride, methacrylic acid, crotonic acid, isocrotonic acid, mesaconic acid, angelic acid, maleic anhydride, itaconic anhydride, citraconic anhydride, acrylonitrile, methacrylonitrile, sodium acrylate, calcium acrylate, and magnesium acrylate.

Other monomers which can be used either by themselves or in combination with one or more of the carboxylic acids or derivatives thereof include C₂-C₅₀ vinyl monomers such as acrylamide, acrylonitrile and monovinyl aromatic compounds, i.e. styrene, chlorostyrenes, bromostyrenes, alpha.-methyl styrene, vinyl pyridines and the like. Other monomers which can be used are C₄ to C₅₀ vinyl esters, vinyl ethers and allyl esters, such as vinyl butyrate, vinyl laurate, vinyl stearate, vinyl adipate and the like.

The preferred monomers to be grafted to the block copolymers according to the present invention are maleic anhydride, maleic acid fumaric acid and their derivatives. It is well known in the art that these monomers do not polymerize easily. Of course, mixtures of monomers can be also added so as to achieve graft copolymers in which the grafted chains have at least two different monomers therein (in addition to the base polymer monomers).

### Preparation of the Functionalized Polymers

The modified block copolymer according to the present invention may be prepared by graft-reacting an acid moiety or its derivative with an aromatic vinyl compound-conjugated diene compound block copolymer containing at least one polymer block B which is a controlled distribution block composed of a mixture of a conjugated diene and a mono alkenyl arene, and at least one polymer block A mainly composed of an aromatic vinyl compound, wherein said graft reaction is carried out by melt-mixing said block copolymer and said acid moiety in the presence of a free radical initiator and wherein each A is a polymerized monoalkenyl aromatic hydrocarbon block having an average molecular weight of about 2,000 to 115,000; each B is a polymerized controlled distribution block of conjugated diene and mono alkenyl arene having an average molecular weight of about 20,000 to 450,000; the blocks A constitute 5-95 weight percent of the copolymer; 40-55 mol percent of the condensed butadiene units in block B have a 1,2-configuration; the unsaturation of the block B is reduced to less than 10% of the original unsaturation; and the unsaturation of the A blocks is above 50% of the original unsaturation.

The grafting reaction is initiated by a free-radical initiator, which is preferably an organic peroxygen compound. Especially preferred peroxides are 2,5-dimethyl-2,5-di(t-butylperoxy)hexane, di-t-butyl peroxide, 2,5-dimethyl-2,5-di-tert-butylperoxy-3-hexyne (Lupersol 130), .alpha.,.alpha.′-bis(tert-butylperoxy)diisopropyl benzene (VulCup R), or any free radical initiator having a short half-life under the base polymer processing conditions. See pp. 66-67 of Modern Plastics, November 1971, which is incorporated hereby reference, for a more complete list of such compounds.

The concentration of the initiator used to prepare the modified polymer may vary between wide limits and is determined by the desired degree of functionality and degradation allowable. Typical concentrations range from about 0.001 weight percent to about 5.0 weight percent, more preferably between 0.01 and 1.0 weight percent.

### Reaction Conditions

Reaction temperatures and pressures should be sufficient to melt the reactants and also sufficient to thermally decompose the free radical initiator to form the free radical. Reaction temperatures would depend on the base polymer being used and the free radical initiator being used. Typical reaction conditions can be obtained by using a screw type extruder to mix and melt the reactants and to heat the reactant mixture to the desired reaction temperature.

The temperatures useful in the reaction of the process of the present invention may vary between wide limits such as from +75° C. to 450° C., preferably from about 200° C. to about 300° C.

The process of the invention is highly flexible and a great many modifications such as those proposed above are available to carry out any particular purposes desired.

Of course, any of the standard additives can be used with these modified polymers. They include conventional heat stabilizers, slip-agents, antioxidants, antistatic agents, colorants, flame retardants, heat stabilizers, plasticizers, preservatives, processing aids and the like.

Furthermore, polymers which have been functionalized, particularly those with functional carboxylic acid groups, can be additionally crosslinked in a conventional manner or by using metallic salts to obtain ionomeric crosslinking.

### B. Contact Adhesive Compositions

The invention relates specifically to a solvent sprayable contact adhesive composition comprising the radial polymer composition, a tackifier, a solvent and an optional plasticizer. Suitable aromatic hydrocarbon resins as tackifying resins are those having a relative percentage of aromaticity (based on aromatic protons relative to the total number of protons in the molecule as determined by H-NMR) in the range of 3 to 18%, preferably in the range of 4 to 14%.

Suitable tackifier resins may be selected from the type generally referred to as mixed aliphatic/aromatic resins or so-called heat reactive hydrocarbon resins. These hydrocarbon resins have a mixed aromatic and aliphatic composition. The streams used to produce these resins contain C-9 components (indene and styrene) and various other C-5 monomers or C-5 dimers.

Examples of suitable mixed aliphatic/aromatic resins and heat reactive hydrocarbons include ESCOREZ 2101 (Exxon Chemicals); Wingtack ET and Wingtack 86 (Sartomer); Piccotac MBG 222 and 223 and HERCOTAC 205 (Eastman) (trademarks). The preferred tackifier resin is Wingtack ET, which has a light pale color, and may be used where low color formation is desirable. Though this list may not be comprehensive, to achieve tack a resin with greater than 10% aromatics is needed. Also, contact adhesives can be formulated to give non-PSA properties. In that case, a C5 hydrocarbon resin with less than 10% aromatics may be suitable. The composition according to the present invention preferably comprises from 50 to 400 parts by weight, more preferably from 100 to 300 parts by weight of a tackifying resin, per hundred parts by weight rubber (phr).

Suitable plasticizers include plasticizing oils like low aromatic content hydrocarbon oils that are paraffinic or naphthenic in character (carbon aromatic distribution≦5%, preferably ≦2%, more preferably 0% as determined according to DIN 51378). Those products are commercially available from the Royal Dutch/Shell Group of companies, like SHELLFLEX, CATENEX, and ONDINA oils. Other oils include KAYDOL oil from Sonneborn, or TUFFLO oils from Citgo. Other plasticizers include compatible liquid tackifying resins like REGALREZ R-1018. (SHELLFLEX, CATENEX, ONDINA, KAYDOL, TUFFLO and REGALREZ are trademarks).

Other plasticizers may also be added, like olefin oligomers; low molecular weight polymers (≦30,000 g/mol) like liquid polybutene, liquid polyisoprene copolymers, liquid styrene/isoprene copolymers or liquid hydrogenated styrene/conjugated diene copolymers; vegetable oils and their derivatives; or paraffin and microcrystalline waxes.

The composition according to the present invention may, but need not, contain a plasticizer. If it does, then the composition comprises up to 200 parts by weight, preferably 5 to 150 parts by weight, more preferably 10 to 130 parts by weight of a plasticizer. Indeed, the block copolymer may be pre-blended with a small amount of plasticizer by the manufacturer of said copolymer.

In the present formulations, one of the solvents is a VOC exempt solvent. Some solvents are considered by the government regulators to be VOC exempt because they have little tendency to form ozone. Acetone and p-chlorobenzotriflouride (PCBTF) are exempt solvents. T-butyl acetate is currently exempt in all but 3 states in the United States, with additional exemptions expected later. Acetone is an inexpensive solvent, but its use is limited by its fast evaporation rate, its low flash point and its high solubility parameter. PCBTF (KESSCHEM 100 from Kessler Chemical) has fairly good evaporation characteristics but it is expensive and has high density. TBAc is a very attractive solvent because it has the right evaporation characteristics, it is reasonably priced and it has density typical of common solvents. Regulations for Consumer Products also have a category called Low Vapor Pressure (LVP) solvents, which are considered to be VOC exempt. Solvents which have >12 carbon atoms fall into this category. Conosol C-200 (from Penreco), which is a mixture of C₁₂-C₁₆ isoparaffin/cycloparaffin molecules, is an example of an LVP solvent.

Preferred VOC exempt solvents are acetone, p-chlorobenzotrifluoride and t-butyl acetate. The type and amount of each solvent can be adjusted to obtain the appropriate level of solids, which will not only meet VOC requirements, but also will have the right drying characteristics to give a high quality, smooth, pinhole-free, stress-free coating. Starting amounts to consider are about 20 percent to 30 percent of an aliphatic solvent and about 70 to about 80 percent of VOC exempt solvent. In a preferred embodiment, the solvent is a mixture of heptane and tBAc.

Other rubber components may be incorporated into the adhesive compositions according to the present invention. It is also known in the art that various other components can be added to modify the tack, the odor, and the color of the adhesives. Antioxidants and other stabilizing ingredients can also be added to protect the adhesive from degradation induced by heat, light and processing or during storage. Several types of antioxidants can be used, either primary antioxidants like hindered phenols or secondary antioxidants like phosphite derivatives or blends thereof. Examples of commercially available antioxidants are IRGANOX 565 from Ciba-Geigy (2,4-bis-(n-octylthio)-6-(4-hydroxy-3,5-di-tertiary-butyl anilino)-1,3,5-triazine), IRGANOX 1010 from Ciba-Geigy (tetrakis-ethylene-(3,5-di-tertiary-butyl-4-hydroxy-hydrocinnamate)methane) and POLYGARD HR from Uniroyal (tris-(nonyl-phenyl)phosphite). (IRGANOX and POLYGARD are trademarks).

No particular limitation is imposed on the preparation process of the adhesive composition. Therefore, there may be used any process such as a mechanically mixing process making use of rolls, a Banbury mixer or a Dalton kneader, a hot-melt process characterized in that heating and mixing are conducted by using a melting kettle equipped with a stirrer, like a high shear Z-blade mixer or a single- or twin-screw extruder, or a solvent process in which the compounding components are poured in a suitable solvent and stirred, thereby obtaining an intimate solution of the contact adhesive composition. Other processes may be used to mix and apply the adhesive composition.

### EXAMPLES

The following examples are provided to illustrate the present invention. The examples are not intended to limit the scope of the present invention and they should not be so interpreted. Amounts are in weight parts or weight percentages unless otherwise indicated.

### Example 1

Tests were run regarding room temperature solution viscosity on formulated solutions, SAFT on Mylar to Mylar, ash wood to ash wood, melamine to ash wood, 180° peel on Mylar to steel, canvas to canvas, canvas to polyurethane foam, and lap shear—ash wood to ash wood. Except for solution viscosity, each test was replicated three times. Solution viscosity was run once. Where canvas was used, it was soaked in a primer solution (shown below) and dried for one week in a hood prior to applying the adhesive for testing.

| Primer Solution | Percent weight |
|---|---|
| KRATON G1652 polymer | 10 |
| Picco 6100 end block | 25 |
| resin | |
| Irganox 1010 antioxidant | 1 |
| Toluene | 65 |

Kraton® G 1652 polymer is a selectively hydrogenated S-EB-S block copolymer available from Kraton Polymers. Picco 6100 resin is a hydrocarbon resin produced from aromatic monomers, available from Eastman Chemical.

Formulations were based on polymers G1652, FG1901, MD6670, G1657, or MD6932. MD6670 is maleated RP6936 according to the present invention. MD6670 has about 1 weight percent grafted maleic anhydride. Kraton RP6936 polymer is an S-EB/S-S block copolymer where styrene has been added to the rubber block in a controlled distribution. Kraton MD6932 polymer is an S-EB-S with a high vinyl rubber block. Kraton G 1652 polymer is a conventional S-EB-S block copolymer. Kraton FG1901 polymer is a maleated S-EB-S block copolymer. Kraton G1657 polymer is a partially coupled S-EB-S block copolymer. The VOC exempt solvent was t-butylacetate (tBAc). However, it must be blended with an aliphatic solvent to get complete dissolution of hydrogenated polymers. Therefore heptane:tBAc were blended at a ratio of 22:78. Resins used were C₅ aliphatic hydrocarbon Piccotac 1095 and C₉ aromatic hydrocarbon Picco 6100. Stabilizer Irganox 1010 hindered phenolic was used for all formulations. Polymers used are listed below with product characteristics.

TABLE 1
Product Characteristics

| Polymer | G1652 | FG1901 | G1657 | MD6932 | MD6670 |
|---|---|---|---|---|---|
| Styrene, % | 29.9 | — | 13 | 20.0 | 19 |
| Total styrene, % | 29.9 | — | 13 | 20.0 | 39 |
| MW, M | 79.0 | — | 145.0 | 143.0 | — |
| Diblock content, % | <1 | — | 29 | 7.0 | — |
| Tg of rubber, ° C. | −55 | −55 | −55 | −30 | −25 |
| Toluene solution | 1,800 | 5,000 | 4,200 | 210 | — |
| visc, 25% polymer, | | | | | |
| cps | | | | | |
| Melt flow, | 6.0 | 22 | 24.0 | 75 | 35 |
| 230 C./5 kg | | | | | |
| Structure | linear | linear | linear | | |
| Bound functionality, | none | 1.7 | none | none | 1 |
| % weight | | | | | |

Contact adhesive formulation shown in Table 2 show results with toluene or heptane/t-butylacetate solvent blend at high solids content. Table 3 show results with same solvents but at low solids content. Solutions initially were made at low solids to target 200 cps. Because dry film thickness of 4-6 mils could not be achieved at low viscosities without sagging and skinning in achieving spray depth, high solids made to target 2,000 cps for 180 peels and lap shear.

TABLE 2
Formulations with HSBC Polymers at Low Solids

| | Formulation | | | | | | | | | |
|---|---|---|---|---|---|---|---|---|---|---|
| | 1a | 1b | 2a | 2b | 3a | 3b | 4a | 4b | 5a | 5b |
| G1652 | 100 | 100 | | | | | | | | |
| FG1901 | | | 100 | 100 | | | | | | |
| G1657 | | | | | 100 | 100 | | | | |
| MD6932 | | | | | | | 100 | 100 | | |
| MD6670 | | | | | | | | | 100 | 100 |
| PICCOTAC 1095 | 50 | 50 | 50 | 50 | 50 | 50 | 50 | 50 | 50 | 50 |
| PICCO 6100 | 50 | 50 | 50 | 50 | 50 | 50 | 50 | 50 | 50 | 50 |
| IRGANOX 1010 | 2 | 2 | 2 | 2 | 2 | 2 | 2 | 2 | 2 | 2 |
| Toluene | 875 | | 1470 | | 680 | | 455 | | 1175 | |
| Heptane/tBAC | | 865 | | 700 | | 1125 | | 425 | | 575 |
| Calc. % w Solids | 19 | 19 | 12 | 22 | 23 | 15 | 31 | 32 | 15 | 26 |
| Viscosity, cps | 184 | 182 | 192 | 183 | 184 | 180 | 180 | 178 | 164 | 184 |
| Dry to touch, min | 2.5 | 3 | 2 | 4 | 1.5 | 3 | 1.5 | 4 | 1.7 | 4 |

*Because sample 3 viscosity dropped below 700 cps at ratio of 22:78 for heptane/tBAc, the solvent ratio was adjusted to 33:67.

TABLE 3
Formulations with HSBC Polymers at High Solids

| | Formulation | | | | | | | | | |
|---|---|---|---|---|---|---|---|---|---|---|
| | 1a | 1b | 2a | 2b | 3a | 3b | 4a | 4b | 5a | 5b |
| G1652 | 100 | 100 | | | | | | | | |
| FG1901 | | | 100 | 100 | | | | | | |
| G1657 | | | | | 100 | 100 | | | | |
| MD6932 | | | | | | | 100 | 100 | | |
| MD6670 | | | | | | | | | 100 | 100 |
| PICCOTAC 1095 | 50 | 50 | 50 | 50 | 50 | 50 | 50 | 50 | 50 | 50 |
| PICCO 6100 | 50 | 50 | 50 | 50 | 50 | 50 | 50 | 50 | 50 | 50 |
| IRGANOX 1010 | 2 | 2 | 2 | 2 | 2 | 2 | 2 | 2 | 2 | 2 |
| Toluene | 425 | | 660 | | 300 | | 250 | | 655 | |
| Heptane/tBAC | | 530 | | 335 | | 675 | | 320 | | 300 |
| Calc % w Solids | 32 | 28 | 23 | 38 | 40 | 23 | 45 | 39 | 24 | 40 |
| Viscosity, cps | 1280 | 918 | 445 | 2780 | 2875 | 1980 | 1020 | 430 | 2900 | 3600 |
| Dry to touch, min | 3.8 | 6 | 3.2 | 6 | 3.5 | 6 | 3.5 | 10 | 3.8 | 9 |

Once canvas to polyurethane (PU) was sprayed with high solids contact adhesive, a ten-minute open time was given before bonding. Assembled samples were annealed for seven days before testing. All canvas to non-brittle polyurethane (PU) foams failed the same regardless of polymer(s) used. PU tore rather than failing at adhesive bond line. All the a samples were dissolved in toluene. All the b samples were dissolved in t-BAc/heptane blend.

TABLE 4
180° Peel results for sprayable contact adhesive - canvas to PU foam

| Results | 1a | 1b | 2a | 2b | 3a | 3b | 4a | 4b | 5a | 5b |
|---|---|---|---|---|---|---|---|---|---|---|
| Polymer | G1652 | | FG1901 | | G1657 | | MD6932M | | MD6670 | |
| 180° | 1.0 | 0.7 | 0.2 | 0.1 | 5.6 | 0.2 | 0.5 | 3.5 | 7.8 | 4.5 |
| Peel - | | | | | | | | | | |
| Canvas | | | | | | | | | | |
| to PU, | | | | | | | | | | |
| lb/in² | | | | | | | | | | |
| Std | 0.01 | 0.60 | 0.02 | 0.1 | 0.7 | 0.03 | 0.1 | 0.7 | 0.1 | 1.0 |
| Devi- | | | | | | | | | | |
| ation | | | | | | | | | | |
| Mode | FT | C | C | C | FT | C | C | FT | FT | FT |
| of | | | | | | | | | | |
| Failure | | | | | | | | | | |

FT = foam tear,
C = cohesive tear

### CONCLUSIONS

Formulated MD6670 according to the invention yielded higher 180° Peel (canvas to PU Foam) compared to controls with G1652 or FG1901. Failure mode for formulated MD6670 was foam tear where the other polymers failed mostly cohesively. A foam tear failure is an indication the adhesive bond was stronger than the foam. A cohesive tear is thought to show that it had good adhesion to the foam, and that the adhesive was weaker than the foam product. Formulations containing both polar polymers (FG1901X and MD6670) gave higher solids with tBAC/heptane blends than in toluene at a given viscosity.

What is claimed is:

1. A solvent sprayable contact adhesive composition comprising (i) one or more block copolymers, (ii) one or more tackifying resins, (iii) one or more solvents and (iv) optionally, one or more plasticizers, wherein at least one of the block copolymers is a block copolymer composition comprising:
a functionalized, selectively hydrogenated block copolymer having the general configuration A-B, A-B-A, (A-B)ₙ, (A-B-A)ₙ, (A-B-A)ₙX, (A-B)ₙX or mixtures thereof, where n is an integer from 2 to about 30, and X is coupling agent residue and which has been grafted with an acid compound or its derivative, wherein:
a. prior to hydrogenation each A block is a mono alkenyl arene polymer block and each B block is a controlled distribution copolymer block of at least one conjugated diene and at least one mono alkenyl arene;
b. subsequent to hydrogenation about 0-10% of the arene double bonds have been reduced, and at least about 90% of the conjugated diene double bonds have been reduced;
c. each A block having a number average molecular weight between about 3,000 and about 60,000 and each B block having a number average molecular weight between about 30,000 and about 300,000;
d. each B block comprises terminal regions adjacent to the A blocks that are rich in conjugated diene units and one or more regions not adjacent to the A blocks that are rich in mono alkenyl arene units;
e. the total amount of mono alkenyl arene in the hydrogenated block copolymer is about 20 percent weight to about 80 percent weight; and
f. the weight percent of mono alkenyl arene in each B block is between about 10 percent and about 75 percent.

2. The adhesive composition of claim 1 where said acid compound or its derivative is selected from the group consisting of maleic anhydride, maleic acid, fumaric acid, and their derivatives.

3. The adhesive composition of claim 1, which comprises 100 parts by weight of said block copolymer composition, 50 to 400 parts by weight of said tackifier resin, and 100 to 1500 parts by weight of a VOC-exempt solvent.

4. The adhesive composition of claim 2 wherein said mono alkenyl arene is styrene.

5. The adhesive composition of claim 4 wherein said block B has a glass transition temperature (Tg) less than about −20° C. as determined according to ASTM E-1356-98.

6. The adhesive composition of claim 5 wherein each block A has a weight average molecular weight of about 5,000 to about 17,000 and each B block has a weight average molecular weight of about 50,000 to about 100,000.

7. The adhesive composition of claim 6 wherein said block copolymer is a linear block copolymer.

8. The adhesive composition of claim 2 wherein said solvent is a VOC-exempt solvent selected from the group consisting of acetone, p-chlorobenzotrifluoride and t-butyl acetate.

9. The adhesive composition of claim 8 wherein said VOC-exempt solvent is t-butyl acetate.

10. The adhesive composition of claim 2 wherein the solvent is a mixture of heptane and t-butyl acetate.

11. The adhesive composition of claim 10 wherein said tackifying resin is an aliphatic hydrocarbon resin.

12. The adhesive composition of claim 1 wherein the acid compound is maleic acid.

13. The adhesive composition of claim 1 wherein the acid compound or its derivative is maleic anhydride.

14. The adhesive composition of claim 1 wherein the grafted acid compound or its derivative is present at between about 0.02-20 weight percent.

15. The adhesive composition of claim 14 wherein the grafted acid compound or its derivative is present at between about 0.1-10 weight percent.

16. The adhesive composition of claim 15 wherein the grafted acid compound or its derivative is present at between about 0.2-5 weight percent.
